(19) United States
(12) Patent Application Publication
(10) Pub. No.: US 2003/0025009 A1
(43) Pub. Date: Feb. 6, 2003

(54) Irrigation pipe wind brace

(76) Inventor: Shad Roundy, Cache Junction, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/054,383

(22) Filed: Jan. 22, 2002

Related U.S. Application Data
(60) Provisional application No. 60/263,149, filed on Jan. 22, 2001.

(51) Int. Cl. B05B 3/00

(52) U.S. Cl. 239/741; 188/7

(57) ABSTRACT

The present invention relates to a braking method and apparatus. The method of the present invention comprises securing a first end of a connecting means to a first irrigation line, and securing a second end of said connecting means to a second irrigation line. The apparatus of the present invention comprises a rigid connecting means having a desired length for connecting a first side role irrigation line to a second side role irrigation line. The connecting means is of sufficient strength to secure a first irrigation line to a second irrigation line, where were either irrigation line is being influenced to move by wind blowing against the line. The connecting means the should have a weight such as not to bend or deform the irrigation line to which it is secured. Alternatively, the connecting means may have a support system to take weight off of the line when the connecting means is secured to the line. The weight of the connecting means may provide resistance to movement of the line under the force of the wind. The weight is such that when the connecting means is stored on the irrigation line, the weight does not impede the normal operation of the side role irrigation line.

### BACKGROUND

1. Field of the Invention

This application claims priority to application serial No. 60/263,149, filed Jan. 22, 2001.

The present invention relates to a method and apparatus for securing and braking side role irrigation lines. More specifically, the present invention relates to a method and apparatus for securing a first side role irrigation line to a second side role irrigation line to prevent undesired movement of the irrigation lines caused by wind.

2. Background Art

Side role irrigation lines apply water over fields in a way that is less labor-intensive than hand move irrigation pipe and less costly than center or line-move irrigation systems. However, one of the disadvantages of side role irrigation systems is that because of their light weight design, when the irrigation lines are empty, the unit though long is easily move by strong winds. The undesired and unplanned relocation of lines due to wind costs the farmer both time and effort to retrieve an irrigation line and relocate it to its proper position. Moreover, the unregulated movement of the line may result in damage to the line, as the line moves unevenly across a field or runs into obstructions that break or otherwise damage the line.

Prior art devices have been designed to attempt to remedy this problem. U.S. Pat. No. 4,191,206 to Baker discloses an automatic wind placement will for side row irrigation systems. The patent specification states:

[Baker's] invention provides for wheel supported, side role irrigation system and automatic wind brace which includes an elongated brace member mounted pivotally adjacent its inner end on a base member supported by the irrigation system and location radially outward of the axis of the supporting wheels, and an extensible damper member pivotally interconnecting the base and brace members for delaying movement of the brace member from its retracted inoperative position disposed substantially parallel to the irrigation pipe, to its extended, operative position projecting angularly downward into engagement of its outer end with the ground. Column 1 lines 47—60.

U.S. Pat. No. 4,5 2,464 to Cornelius et al. discloses an irrigation system that includes an irrigation line and a wind brace assembly which can be automatically disengaged from the irrigation line preparatory to moving the irrigation line across the field to a new position. The assembly is automatically engaged with the irrigation line in the new position to prevent wind for moving irrigation line.

U.S. Pat. No. 4,452,398 to Wheaton et al. discloses a breaking mechanism for mobile irrigation systems in general. A vertically adjustable elongated field brake member is clamped around and carried by the irrigation pipe itself.

The devices and methods of the prior art have several disadvantages. In some cases, the devices used to slow or brake the movement of the irrigation line require some portion of the devices be staked into place or otherwise secured into the ground. Prior art devices that use a separate stake or some other ground anchoring device can cause problems when the field is later plowed. If the ground anchoring device is mistakenly left in the ground it becomes a damaging obstruction when the field is plowed.

One of the main problems with a prior art devices is that they must be somehow positioned so that the breaking system applies a breaking force in a direction that pushes against the force of the wind. However, once the break is set to prevent movement from wind coming with in a particular direction, if the wind should change direction, the brake may be ineffective. In order to function properly in changing winds, the braking system must have an automatic means for the repositioning the brake or must be repositioned manually.

Many of the prior art systems are intended to be placed on irrigation lines when they lines are not operating and then removed from irrigation line when the line is functioning, that is, when the line is moving through and watering the field, or when a wind brake is not needed. The prior art braking systems may of necessity be stored separately from the irrigation line. The prior art systems may require additional, obstructive hardware in order to store the braking system on the irrigation line. Finally, many of the breaking systems have complicated and expensive mechanical parts that increase expense of the manufacturing and require maintenance to keep them functioning properly.

### SUMMARY AND OBJECTS IN THE INVENTION

The present invention relates to a braking method and apparatus. The method of the present invention comprises securing a first end of a connecting means to a first irrigation line, and securing a second end of said connecting means to a second irrigation line.

The apparatus of the present invention comprises a rigid connecting means having a desired length for connecting a first side role irrigation line to a second side role irrigation line. The connecting means is of sufficient strength to secure a first irrigation line to a second irrigation line, where were either irrigation line is being influenced to move by wind blowing against the line. The connecting means the should have a weight such as not to bend or deform the irrigation line to which it is secured. Alternatively, the connecting means may have a support system to take weight off of the line when the connecting means is secured to the line. The weight of the connecting means may provide resistance to movement of the line under the force of the wind. The weight is such that when the connecting means is stored on the irrigation line, the weight does not impede the normal operation of the side role irrigation line.

The invention further comprises at least two securing means. Disposed on one end of the connecting means is a first securing means. A second securing means is a disposed on the other end of the connecting means. The two securing means rigidly secure each irrigation line to the connecting means and thereby secure the lines to each other. The securing means may be positioned about the irrigation line in such a way as to prevent the irrigation line from moving freely when blown by the wind. The securing means is designed to connect to or be disposed around the irrigation line in such a way that when the wind applies force against the line and subsequently against the securing means, the resistive force of securing means is spread across a sufficient area of the irrigation line that resistive force does not damage or deform the irrigation line. The force of the wind against irrigation line should not damage the irrigation line of the point resistance provided by the securing means.

It is an object of one embodiment of the present invention to provide a braking method and apparatus that reduces the likelihood that the irrigation line to be blown over the apparatus and thereby rendered ineffective.

It is another object of one embodiment of the present invention to provide a braking method and apparatus for side role irrigation lines that secures one line to another and does not require the line to be secured into the ground.

It is another object of one embodiment of the present invention to provide a braking method and apparatus for side role irrigation lines that inhibits movement of the irrigation line regardless of wind direction.

It is another object of one embodiment of the present invention to provide a braking method and apparatus for side role irrigation lines that does not require complicated machinery and has few moving parts.

It is another object of one embodiment of the present invention to provide a braking method and apparatus for side role irrigation lines that can be conveniently unobtrusively stored on the irrigation line itself when not in use.

### BRIEF DESCRIPTION OF THE DRAWINGS

FIG. 1 shows one embodiment of the present invention, securing a first irrigation line to a second irrigation line;

FIG. 2 shows the securing means of FIG. 1 secured to an irrigation line, said securing means being disposed on one end of the connecting means, also shown is a protective sleeve;

FIG. 3 shows a side view of the securing means of the embodiment of FIG. 2;

FIG. 4 shows another perspective view of the securing means disposed on the connecting means to the protective sleeve of the embodiment in FIG. 2;

FIG. 5 shows a top view of a protective sleeve disposed about the irrigation line;

FIG. 6 shows a perspective view of the sleeve of FIG. 5;

FIG. 7a shows the apparatus of the present invention being conveniently stored on the irrigation line, using the securing means;

FIG. 7b shows a front view of the apparatus of FIG. 7b being stored on the irrigation line;

FIG. 8 shows the two side role irrigation lines in position to secured with the apparatus of the present invention;

FIG. 9 shows irrigation lines of FIG. 8 secured by one embodiment of the present invention; and

FIG. 10 shows an example of a prior art braking device.

The present invention comprises a rigid connecting means having a desired length, sufficient strength, and appropriate weight. As explained above, disposed on one end of the connecting means is a first securing means with a second securing means disposed on the other end. The first and second securing means rigidly secure each irrigation line to the connecting means and thereby secure the irrigation lines to each other. The connecting means may take anyone of a number of forms but is preferably an elongated form having at least two ends. The shape and form may be round and rod-like member or angled and beam-like. The connecting means may be solid or hollow, and may be constucted of any number of materials, for example metal, wood, resin, or plastic.

The securing means is a mechanical device component that is secured to the irrigation line by friction fit of some means of mechanical attachment and thereby provides resistance to the movement of the irrigation line. As mentioned above, each securing means is positioned on or about the respective irrigation line to prevent the irrigation lines from moving. The securing means secure the line in such away so that the resistive force of securing means is provided across an expanded surface area of the irrigation line. With the present invention properly installed, the force of the wind against irrigation line should not move or damage the irrigation at the point where the securing means is attached. The securing means may be attached to the connecting means in a removable fashion.

The securing means can take numerous embodiments, for example, the securing means may be a collar, clamp, bracket, or some other form of attachment. The securing means may be adjustable to fit a variety of irrigation line diameters or may be adjustable to more precisely the fitted around a particular line diameter. The securing means may be hinged so as to close around the irrigation line when being installed or may be designed with the resistance fitting. Likewise, the securing means could be a multi-piece component that is secured using a mechanical means around the line, such as being bolted on to the line. Securing means can be made of materials available in the art such as plastic, resin, metal or any other suitable materials.

A protective sleeve may be provided to protect the irrigation line from damage caused by the securing means. The protective sleeve forms a barrier between the securing means and the irrigation line. The sleeve allows the securing means to be attached tightly to the sleeve while providing the irrigation line a measure of protection from damage. The sleeve my also assist in providing a larger surface area against which the resistive force of the present invention of can be applied. The cut the protective sleeve can be made of the same types of materials used in the securing means or can be made of different types of materials that are pliable, elastic, or malleable materials, such as rubber. Various embodiments which allow the present invention to be stored on the irrigation line in an unobtrusive matter are contemplated. For example, in an embodiment not shown in the figures, a hinged securing means may be provided which allows convenient storage. One securing means may be disengaged from one irrigation line, with the second securing means remaining attached to the irrigation line on which the device will be stored. The device is turned upon the hinge proximate to the attached securing means, so that the connecting means runs parallel to irrigation line. The loose, unattached securing means can then be reattached to the same irrigation line on which the apparatus will be stored. In this way the apparatus is may be conveniently stored on irrigation line.

In another embodiment, the securing means can be removed from the ends of the connecting means and reattached to other parts of the connecting means to allow for storage, such as in the example discussed below. The connecting means could therefore be reattached in a different configuration allowing the appartus to be carried by the irrigation line in an unobtrusive matter.

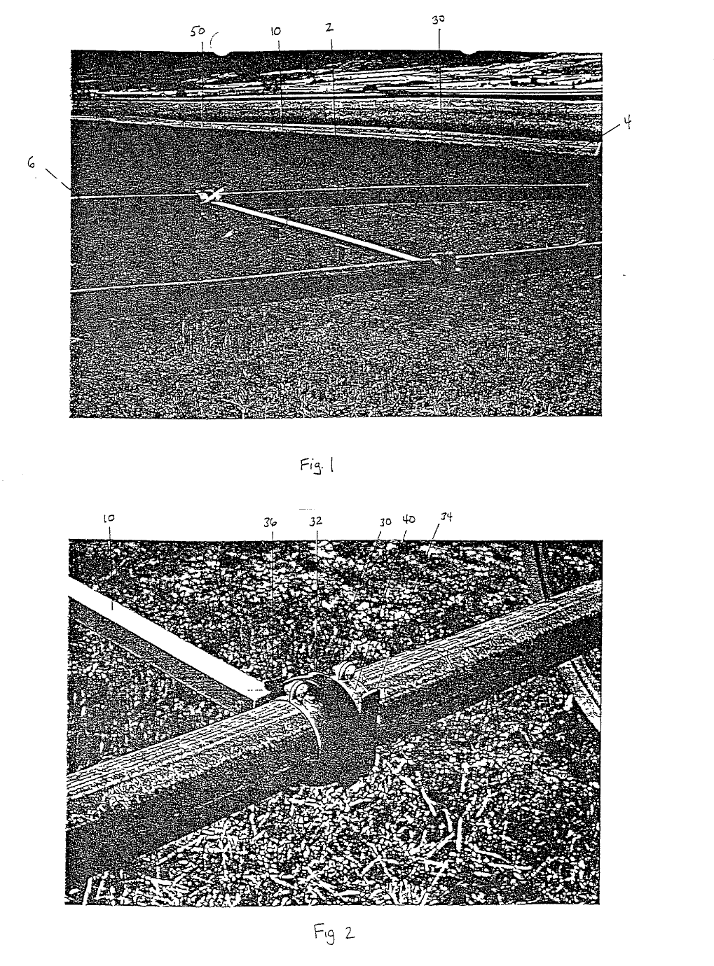

FIG. 1 shows one embodiment of the present invention, an apparatus 2 comprising a connecting means 10, a first securing means to 30 and second securing means 50. Connecting means 10 is constructed of hollow, metallic rectangular tubing. Securing means 30 and 50 are attached to opposite ends of connecting means 10. Securing means 50 is disposed around irrigation line 4 and securing means 30 is disposed around irrigation line 6. The apparatus 2 provides the braking mechanism for the irrigation lines 4 and 6.

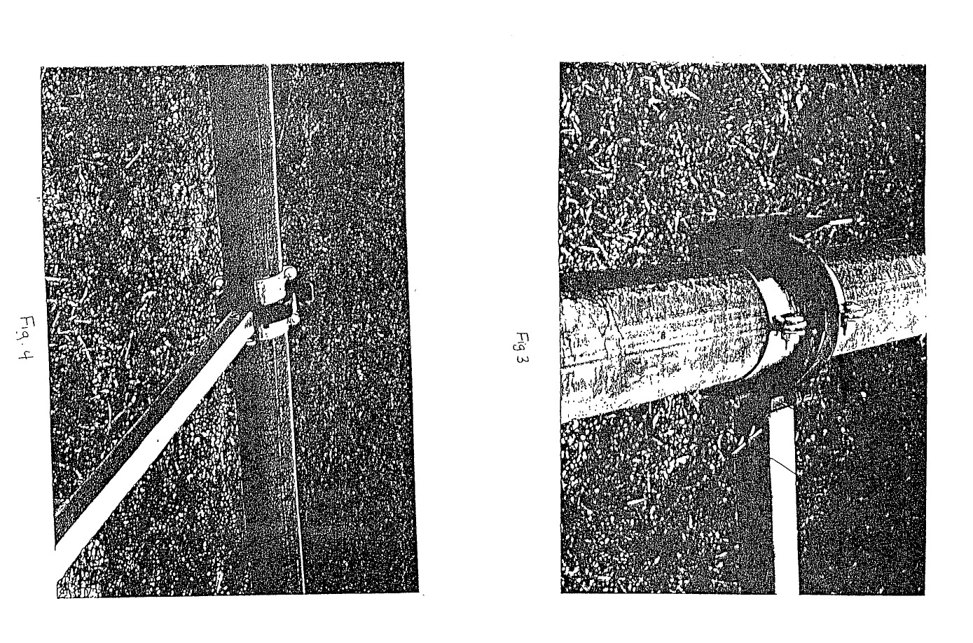

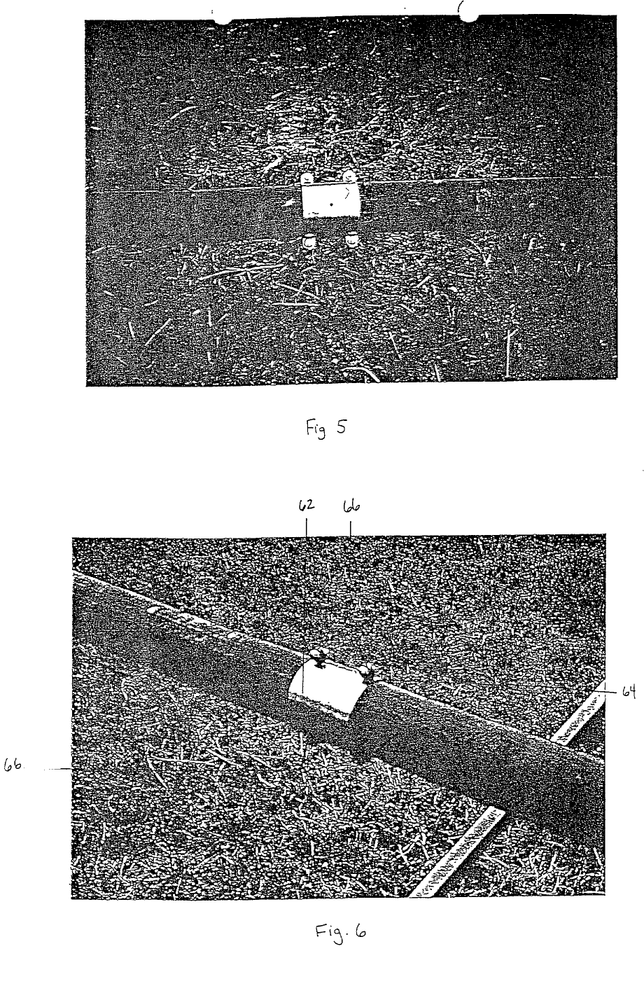

FIGS. 2, 3 and 4 show a detail of the preferred embodiments of securing means 30 and protective sleeve 40. Securing means 30 comprises a circular clamp 32 having a hinge 36 allowing the clamp to be opened the enclosed about irrigation line six. A lever 34 provides a releasable locking mechanism for the clamp and allows the clamp 32 to be adjusted around line six. FIG. 3 shows a projection 38 positioned proximate hinge 36. The projection allows the clamp to be inserted into the orifice defined by the rectangular tubing of connecting means 10. When inserted into the orifice, projection 38 allows securing means 30 to be removably attached to connecting means 10. In this embodiment, an attaching pin 42 secures a bolt 44 extending through connecting means 10, thus providing a means for releasably attaching the securing means 30 to connecting means 10.

FIGS. 5 and 6 show a protective sleeve 60 disposed about an irrigation line 6. The protective sleeve is metallic and is capable of withstanding the restrictive force of clamp 32 such that when clamp 32 is adjusted about irrigation line 6, irrigation line six is not damaged or deformed. Protective sleeve 60 comprises two portions, a first portion 62 and a second portion 64, joined together about line 6 by of bolts 66.

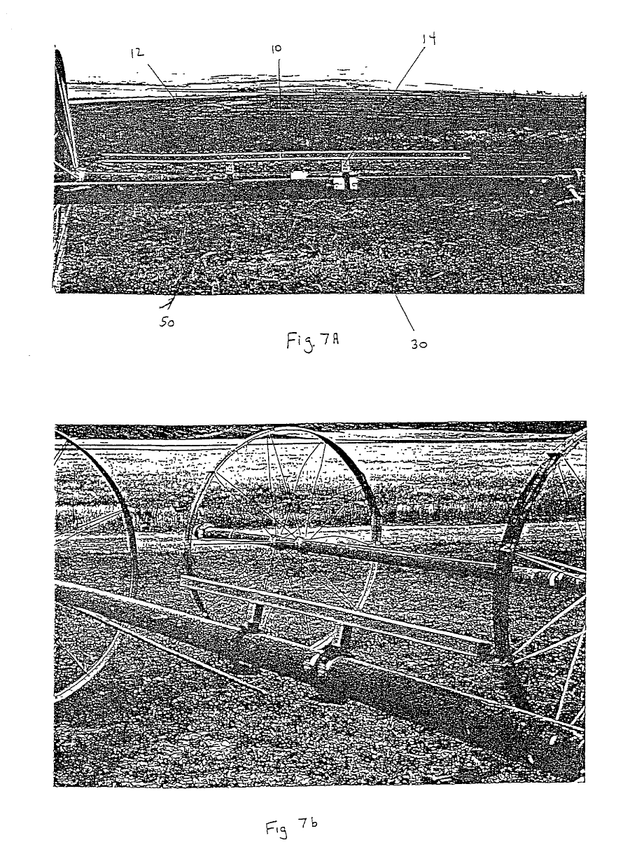

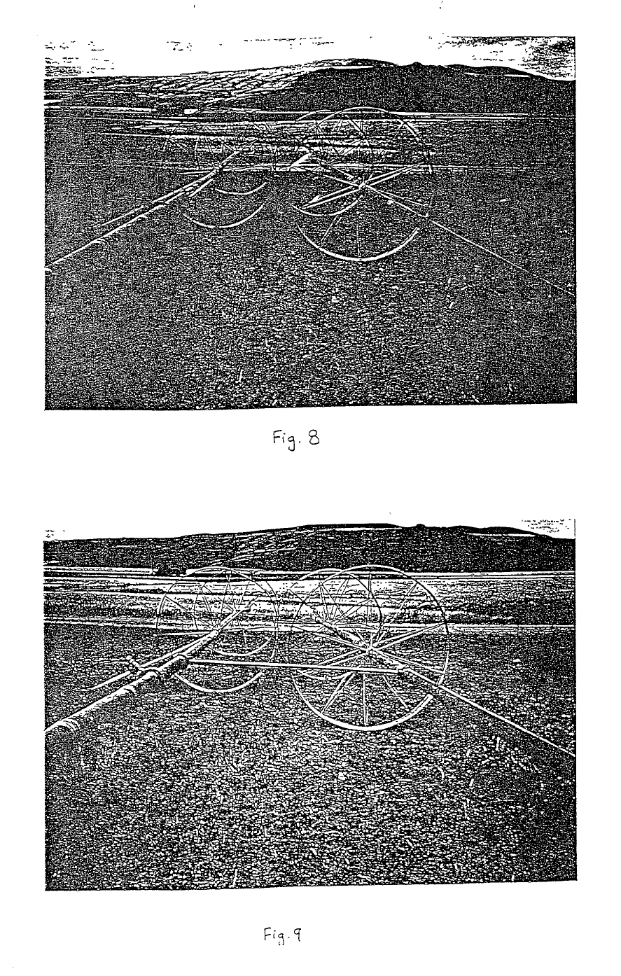

FIGS. 7a and 7b show the present invention stored on irrigation line 6. Storage attachments 12 and 14 allow securing means 30 and 50 to be reconfigured onto connecting means 10, so that connecting means 10 runs parallel to irrigation line 6. Securing means 50 remains firmly disposed around protective sleeve 40 while securing means 50 is loosely disposed around irrigation line 6. The protective sleeve from irrigation line 4 does not need to be removed and replaced on line 6 in order to store apparatus 2 on irrigation line 6. However it may be removed from line 4 and so installed if desired.

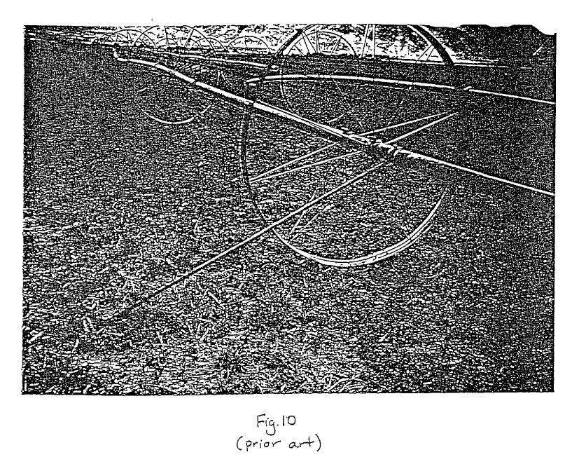

FIG. 8 shows irrigation lines 4 and 6 positioned to be secured and connected to each other using the present invention. FIG. 9 shows apparatus 2 disposed on and about irrigation lines 4 and 6 to restrict the movement of lines.

What is claimed:

1. A brake for side roll irrigation lines comprising:
a rigid connecting means having a length sufficient to releasably secure a first irrigation line to a second irrigation line and having a first end and a second end;
a first securing means attached to the connecting means at the first end, the first securing means secured to the first irrigation line; and
a second securing means attached to the connecting means at the second end, the second securing means secured to the second irrigation line.

2. The brake of claim 1 wherein the connecting means is constructed of hollow tubing.

3. The brake of claim 1 wherein the first securing means is secured to the first irrigation line by friction fit.

4. The brake of claim 1 wherein the first securing means is secured to the first irrigation line by mechanical attachment

5. The brake of claim 1 wherein the first securing means is a circular, hinged clamp.

6. The brake of claim 1 wherein the first securing means is capable of distributing wind resistive force across an area of the first irrigation line in a manner that does not deform the first irrigation line.

7. The brake of claim 1 further comprising a first protective sleeve disposed about the first irrigation line between the first irrigation line and the first securing means, the protective sleeve forming a barrier between the first securing means and the first securing means.

8. The brake of claim 7 wherein the protective sleeve is constructed of rubber.

9. The brake of claim 1 wherein the brake is stored on an irrigation line when not in use.

10. The brake of claim 1 further comprising a storage attachment on the brake for attaching the brake to a single irrigation line.

11. A braking method for side role irrigation lines comprising the steps of:
securing a first securing means of a rigid connecting means to a first irrigation line, securing a second securing means of the connecting means to a second irrigation line, to releasably connect the first irrigation line to the second irrigation line.

12. The method of claim 11 wherein the connecting means is constructed of hollow tubing.

13. The method of claim 11 wherein the first securing means is secured to the first irrigation line by friction fit.

14. The method of claim 111 wherein the first securing means is secured to the first irrigation line by mechanical attachment

15. The method of claim 111 wherein the first securing means is a circular hinged clamp.

16. The method of claim 111 wherein the first securing means is capable of distributing wind resistive force across an area of the first irrigation line in a manner that does not deform the first irrigation line.

17. The method of claim 11 further comprising a first protective sleeve disposed about the first irrigation line between the first irrigation line and the first securing means, the protective sleeve forming a barrier between the first securing means and the first securing means.

18. The method of claim 17 wherein the protective sleeve is constructed of rubber.

19. The method of claim 11 wherein the connecting means can be stored on an irrigation line when not in use.

20. The method of claim 11 further comprising a storage attachment on the connecting means for attaching the connecting means to a single irrigation line.
